(19) United States
(12) Patent Application Publication
(10) Pub. No.: US 2026/0030654 A1
(43) Pub. Date: Jan. 29, 2026

(54) DYNAMIC VIDEO AUGMENTATION WITH THIRD-PARTY INFORMATION

(71) Applicant: Loop Now Technologies, Inc., San Mateo, CA (US)

(72) Inventors: Ziming Zhuang, Palo Alto, CA (US); Stefan Backor, Zilina (SK); Jerry Ting Kwan Luk, Menlo Park, CA (US); Michal Svrcek, Zilina (SK); Vincent Yang, Redwood City, CA (US)

(73) Assignee: Loop Now Technologies, Inc., San Mateo, CA (US)

(21) Appl. No.: 19/350,541

(22) Filed: Oct. 6, 2025

Related U.S. Application Data
(63) Continuation-in-part of application No. 17/830,393, filed on Jun. 2, 2022.
(60) Provisional application No. 63/196,252, filed on Jun. 3, 2021.
(60) Provisional application No. 63/226,081, filed on Jul. 27, 2021.
(60) Provisional application No. 63/302,593, filed on Jan. 25, 2022.
(60) Provisional application No. 63/332,703, filed on Apr. 20, 2022.
(60) Provisional application No. 63/344,064, filed on May 20, 2022.
(60) Provisional application No. 63/871,030, filed on Aug. 27, 2025.

(51) Int. Cl. G06Q 30/0251; G06Q 30/0601; H04N 21/4725; H04N 21/81

(52) U.S. Cl. CPC G06Q 30/0253; G06Q 30/06333; H04N 21/4725; H04N 21/812

(57) ABSTRACT

Information on one or more products is obtained from a third-party information source. The one or more products can comprise a product, a service, a coupon, or a membership. A video about the one or more products is rendered by a video user interface to a user. The video user interface and the third-party information source are interfaced between each other based on a user interaction with the video user interface. Product information is fetched from a server based on the interfacing between the video user interface and the third-party information source. The video is augmented with further information based on the fetching.

### RELATED APPLICATIONS

This application claims the benefit of U.S. provisional patent application “Dynamic Transfer Of Ecommerce Video Content” Ser. No. 63/871,030, filed Aug. 27, 2025.

This application is also a continuation-in-part of U.S. patent application “Frame And Child Frame For Video And Webpage Rendering” Ser. No. 17/830,393, filed Jun. 2, 2022, which claims the benefit of U.S. provisional patent applications “Short-Form Videos Usage Within A Frame Widget Retail Environment” Ser. No. 63/344,064, filed May 20, 2022, “Tokenizing A Manipulated Short-Form Video” Ser. No. 63/332,703, filed Apr. 20, 2022, “Ecommerce Purchase Within A Short-Form Video Environment” Ser. No. 63/302,593, filed Jan. 25, 2022, “Video Stream Interface Based on Third-Party Webpage Information” Ser. No. 63/226,081, filed Jul. 27, 2021, and “Frame and Child Frame For Video And Webpage Rendering” Ser. No. 63/196,252, filed Jun. 3, 2021.

Each of the foregoing applications is hereby incorporated by reference in its entirety.

### FIELD OF ART

This application relates generally to display and more particularly to video stream interface based on third-party webpage information.

### BACKGROUND

In the earliest days of humanity, finding food and adequate shelter for oneself and one's immediate family was considered sufficient, if not fortunate. While people gathered in close-knit groups and communities, subsistence living was the normal state of being for most. As communities grew larger and established more permanent locations, the ability to diversify skills and produce more food, clothing, and tools than were needed for immediate needs began to emerge. Hunting, farming, making clothes, shoes, basic tools, and so on became skills that could be handled by different groups of humans working together to the benefit of the whole community. Bartering began to be practiced, many thousands of years ago, as people traded grain, livestock, tools, clothing, and so on in open-air markets or in private trades. As the ability to travel expanded, trade routes developed-first between towns that were close to one another, then between city-states and nations. Wagons and carts hauling goods from locations many miles away came to bustling trade centers in ancient Egypt and the Indus Valley. Pottery, spices, textiles, and a variety of foods were traded while news, ideas, and cultural exchanges were made at the same time. Eventually, currencies were developed as a means of exchange that no longer necessitated moving physical goods from one location to another. Some of the earlier known coinage came from Lydia in Turkey. Coins standardized value, making transactions more efficient. This allowed permanent shops to be established for various goods. In Greece and Rome, shopping venues became commonplace in many towns and cities, offering everything from olive oil to textiles to spices from faraway lands.

As civilizations advanced, shopping venues took on seasonal characteristics. Farmers' markets and fairs drew people both near and far as various crops and produce became available in their seasons. Guilds of skilled workers, artisans, and merchants arose, regulating prices, quality, and competition. In many communities across the globe, the marketplace or bazaars became the center of urban life. As the Renaissance took place in Europe, wealthy patrons began to seek luxury goods from home and abroad. The idea of window shopping began to take shape, as merchants created displays in their stores to attract buyers. Advertising became more sophisticated during these times as well. Simple signs indicating a trade or craft gave way to printed advertising, newspapers, and workers who specialized in attracting buyers, sometimes for a part of the profit of the sales.

Up until this point, the best, if not the only way to know what products might be available, and for how much, was to see for oneself. Going to town was a highlight for many families, bringing goods and money to trade, sell, and buy what one wanted or needed. However, as printing became more commonplace and less expensive, newspapers and magazines began to publish advertising for goods in local markets and shops, as well as products that could be purchased and shipped from towns and cities farther away. Department stores like Harrods and Macy's offered a wide array of products which could be bought in local stores or shipped across the country. Chain stores like Woolworth's, Sears, and Montgomery Ward published catalogs filled with a dazzling array of goods, from clothing to furniture, garden tools to toys, and kitchenware to wood stoves. Credit cards were introduced in the 1950s, allowing consumers to buy now and pay later, over time. Consumption expanded dramatically, fueled by advertising in newspapers, and on radio and television. More recently, the world wide web has moved consumerism into a global marketplace, with goods and services available from across town to across an ocean. Digital storefronts can now be viewed in the privacy of one's own home, with the ability to interact with other users via chats, email, texts, and so on to find the best deals, what products work well, and which may not. As we continue to expand our ability to reach out to one another, our desire to taste, touch, smell, and experience foods, clothing, tools, and entertainment from all over the world will only grow and diversify.

### SUMMARY

Electronic devices can be used to access information of many types on the Internet. The electronic devices, which can include desktop computers, laptop computers, and personal electronic devices such as tablets, smartphones, and PDAs, are widely used by people who want to observe and interact with content such as product information. The product information can be presented in the form of a video stream. The video streams can include livestreams in which an individual or team of individuals can present thoughts and comments, hawk goods and services, and so on. The video streams can be used to promote an individual, a good, or a service, etc.; to present information such as news, sports, government announcements, entertainment, or educational material; and so on. A video stream can be viewed on any of a wide range of electronic devices. The video stream can be viewed in a window associated with a video app or player, by using a plug-in associated with a web browser window, etc. An originator of a video stream, such as an influencer or other individual, can include in their stream one or more products that have come, whether favorably or unfavorably, to the attention of the originator. A viewer can click on a product within the video in order to obtain further information about the product, a good, a service, etc. The further information can include access to a website associated with the individual, details about a good or service that is the subject of the video stream, etc. The further information can be accessed by selecting a product in the video stream. The results of the selecting the product can include detailed information, web content, etc. The web content can include text, photographs or images, audio, videos, etc. The further information can be rendered along with the video. In order for the product and other information and the video to fit within the size of the app or browser window, the product information can be rendered in a window or frame that appears above or “on top” of the original content. The rendering can be accomplished using a frame for the original video and a child frame for product information.

Video display is accomplished using a video stream interface based on third-party webpage information. The third-party information can include product information, where the product information can include text, video, and audio content. Information on one or more products can be obtained from a website by a third party for display. The display enables a video stream interface based on third-party webpage information. The information on the one or more products can include a video stream. The video stream can be provided by an individual, a team, a stream provider, and so on. The video stream can include a livestream video. The video stream is displayed using a video player executing on a device. The video stream can be displayed within a frame or a window associated with the video player. The displaying the video can be accomplished using an app, a window associated with a web browser, and the like. The content that is displayed can include text, images, audio, videos, etc. An interface between the video user interface and the third party captures user interaction with the video interface. User interaction can include clicking, tapping, or otherwise selecting a product about which further information is desired. Product information is fetched from a server, based on the interfacing between the video user interface and the third party. The video is augmented with further information based on the fetching. The further information can be rendered on top of the third-party webpage information. The further information can be displayed within a child frame associated with the video player. The video can be reduced to render the video as a reduced video on a portion of the device display. The reduced video can be rendered and superimposed over the webpage information. The rendering the video along with a webpage from the website is accomplished without a popup window.

Techniques for display using a video stream interface based on third-party information are disclosed. Information on one or more products is obtained from a third-party information source. The one or more products can comprise a product, a service, a coupon, or a membership. A video about the one or more products is rendered by a video user interface to a user. The video user interface and the third-party information source are interfaced between each other based on a user interaction with the video user interface. Product information is fetched from a server based on the interfacing between the video user interface and the third-party information source. The video is augmented with further information based on the fetching.

Disclosed is a computer-implemented method for display comprising: obtaining information on one or more products from a third-party information source; rendering, by a video user interface, to a user, a video about the one or more products; interfacing between the video user interface and the third-party information source, wherein the interfacing is based on a user interaction with the video user interface; fetching product information associated with a product within the one or more products, wherein the fetching is based on the interfacing between the video user interface and the third-party information source; and augmenting the video with further information based on the fetching of the product information associated with the product within the one or more products.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a video stream interface based on third-party information.

FIG. 2 is a flow diagram for cart rendering.

FIG. 3 is an infographic for augmenting a video.

FIG. 4 shows a system block diagram for a video stream interface.

FIG. 5 illustrates webpage information and a video stream on a device.

FIG. 6 is a system block diagram for an add-to-cart operation.

FIG. 7 illustrates providing product information via a shop icon.

FIG. 8 shows product hydration.

FIG. 9 illustrates delivering product information via a video stream.

FIG. 10 is an example that shows a reduced video in a child frame, along with webpage information.

FIG. 11 illustrates a representation of a video stream and website content.

FIG. 12 is a system block diagram for video and webpage rendering.

FIG. 13 is a system diagram for display.

### DETAILED DESCRIPTION

In today's interconnected world, videos are available in many forms and on many devices. Because of their near universal appeal and availability, videos (such as short-form videos, livestreams, livestream replays, etc.) have become popular for increasing engagement. While commonly used for ideas, politics, and amusement, the idea of increasing engagement of products and services through video has also gained popularity. However, videos that simply show a product or service can have limited engagement with the user. For example, users can lose interest mid-way through the video. Alternatively, the video may not answer a key question. As a result, a user may fast forward the video, skipping key information, or may stop watching the video altogether.

Techniques for display based on a video stream interface are disclosed. The video stream interface is based on a third-party information source, such as third-party webpage information. The information source can comprise any type of source, such as a list, a database, and so on. The third-party information can be displayed within a frame and a child frame. A video such as a video stream video, a livestream video, a short-form video, etc. can be received by an individual. The received video stream can be received and viewed using an electronic device such as a desktop computer, a laptop computer, a tablet, a smartphone, a personal digital assistant (PDA), and so on. The video stream video can be viewed using an app such as a video player, a web browser with a video plug-in, and so on loaded on an electronic device. The video stream can enable an individual, a company, a brand, etc. to reach out to their subscribers, followers, fans, like-minded individuals, the curious, and others. The video stream can present a message such as an opinion, an announcement, a product promotion or criticism, etc. The video stream can comprise a video about a product or service for sale, a promotion, an advertisement, and so on. When products are included in the video stream, a video about the products can be rendered to a user by a user interface. Information about the products can be obtained from a third-party information source, such as a database or webpage. The webpage can offer the products for sale. The products within the video stream can be selectable. The selection of one or more products can be accomplished by tapping or clicking a “shop icon” such as a bag or cart, selecting products within a video stream video, mousing over a product, clicking a product, texting about a product, asking a question about a product in a chat window, and so on. By selecting the product, a viewer is able to obtain product details such as size, color, style, availability, configuration details, shipping and handling costs, reviews, and the like. The viewer can choose a particular version of the product, a size and color, etc., and can purchase the product. The providing of the information about the product and purchasing of the product are accomplished by providing an interface between the video user interface and the third party. The video stream can also include a chat feature in which viewers can share comments, endorsements, rants, web links, and much more. The video stream video and the information obtained by the third-party information source can be rendered within a video app or browser window using a frame for the video and a child frame for product information. The product information can be reduced in size and can be rendered over the video stream video.

Video display is enabled using a video stream interface based on third-party information such as a website. Information is obtained on one or more products from an information source, such as a website by a third party. The third-party website can include an information source, a search engine, an online retailer, and so on. A video about the one or more products is rendered by a video user interface to a user. The video user interface can include a video app, a window associated with a web browser, and the like. The video user interface can be executed on a range of electronic devices such as smartphones, PDAs, tablets, and computers. The user can select a product about which she or he desires further information. The video user interface and the third-party information source are interfaced between each other based on a user interaction with the video user interface. The interfacing can be accomplished using a callback function such as a JavaScript™ callback function. Product information is fetched from a server based on the interfacing between the video user interface and the third party. The product information can include information such as size, color, style, fit, sales and promotions, and so on. The product information can include configuration options, shipping rates, etc. The video is augmented with further information, such as the product information, based on the fetching. The augmenting can include showing the product details on top of the video stream. The augmenting can include opening a window or a frame, where the window of the frame can appear to be superimposed “on top” of the video stream in which the product appeared. The augmenting enables the user to further view the product, to select the particular product of interest, to configure the product, and so on. The user can then purchase the product. The purchasing of the product is enabled through the video stream interface and executed on the third-party webpage.

A video stream in which a product is included can include a livestream, a livestream replay, a video stream, a short-form video, and so on. In the case of a livestream video, the video can be provided by an individual who desires to speak about a product, share an opinion about the product, comment on a news story associated with the product, represent a product, and so on. The video stream including the product is displayed in a window or frame on a device display. The window or frame can be associated with an app such as a video app or web browser. The product rendered within the video can be selectable. Selection of the product can be accomplished by familiar device interactions such as swiping, tapping, mousing over, or clicking. The selection of the product enables fetching of product information from a server. The product information can also be fetched from a third-party webpage. The product information that is fetched can be based on the type of product such as clothing, cosmetics, computing hardware, fishing tackle, etc. The product information that is fetched can be rendered within a window or child frame. The product information can be rendered “on top” of the video which contained the product. The product information can be reduced in size prior to rendering on a portion of the device display. The product information can be rendered within a video such as a reduced video. The reduced video can be rendered on top of the video. The reduced video can be rendered initially at a position within the window and can be moved to another position based on an action taken by the user. In embodiments the rendering the video along with a webpage from the website is accomplished without a popup window.

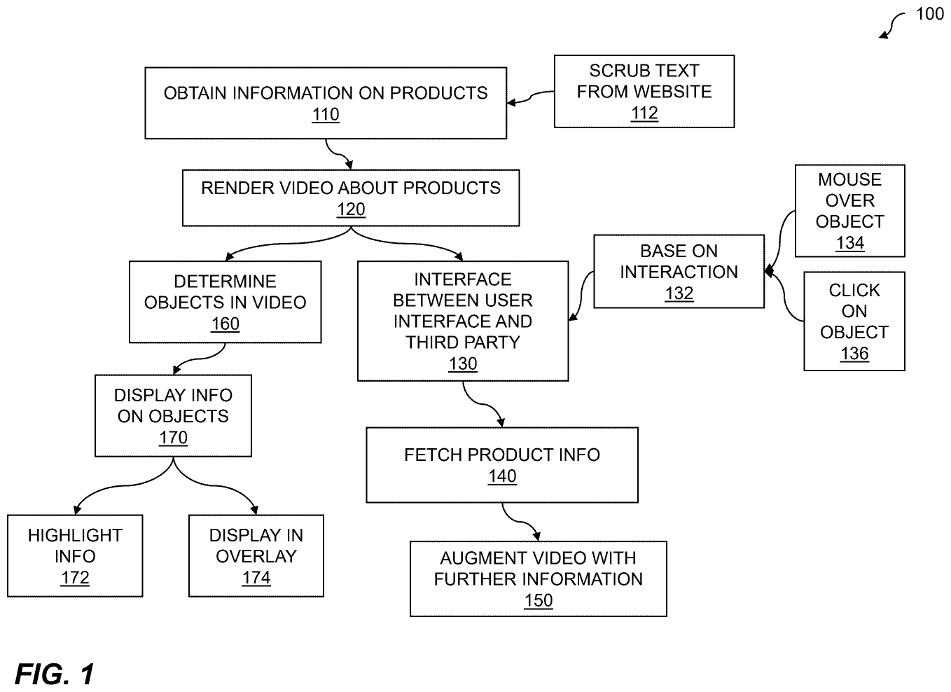

FIG. 1 is a flow diagram for a video stream interface based on third-party information. Videos, which can include livestream videos, video streams, short-form videos, and so on, can include various media and content types. While some videos can include news videos, entertainment videos, political message videos, and so on, video stream videos can include live or recorded videos provided by individuals, teams of collaborators, and the like. The livestream videos can be provided by social media influencers, tastemakers, celebrities, and others. Anyone with access to minimal equipment such as a camera, a microphone, and an electronic device, and who has something to say, can provide a video stream to inform, entertain, or inspire others, or just themselves. Alternatively, brands, retailers, and the like can create videos to promote content pertaining to products or services for sale. The videos can be viewed on an electronic device used by an individual, a user, etc. The viewing can be accomplished by rendering the video within a frame associated with a window. The window can include a window provided by an app, a window associated with a web browser, etc.

The video can include one or more products, where the products can be available for sale on a third-party website. Information associated with the products can include links to other webpages associated with a website; other websites; content such as text, images, audio, and video; and so on. The information can be fetched from a server, such as a server associated with the website, based on a user interacting with a video that she or he is watching. The user interaction can include selection of a product by the user. The information that is fetched can be used to augment a video with information about the one or more products or other information. The augmented video can be rendered in a window or frame associated with the video user interface. Content that results from the interaction can be rendered in a child frame associated with the viewing window, the same frame as the video, or can be rendered using another method. The user can continue to view the video and can interact with the content resulting from the interaction. The video can be paused and restarted, while the contents in the child frame can be scrolled, clicked, etc. The content that results from the interaction can be scrollable in the horizontal orientation, in the vertical orientation, etc.

The flow 100 includes obtaining information on products 110. Embodiments include obtaining information on one or more products from a third-party information source. The products can include a range of goods and/or services. The obtaining can be based on a single product. The one or more products can include a product, a service, a coupon, a promotion, a membership, and so on. The information can include a description of a product; available options for the product such as size, color and fit; availability of the product; shipping and handling charges associated with the product; promotions associated with the product; and so on. In a usage example, a user is interested in a laptop she has seen. The information associated with the laptop that can be obtained can include processor speed, memory capacity, storage capacity, case color, availability, the configured price, free shipping, and the proposed delivery data if ordered now.

In some embodiments, the third-party information source comprises an online retailer. The third party can comprise an individual, a company, a manufacturer, and so on. The third-party information source, from which the information can be obtained, can be varied. In some embodiments, the obtaining information is based on a website by a third-party. The website can include a manufacturer site, an e-commerce site, a local reseller site, etc. The further information (e.g., the product information) can include information about similar products, a comparison of the product to similar products, a reaction, a chat, a transaction, an interaction, reviews, and so on, in addition to the examples listed above. The information can be obtained using a variety of techniques. In some embodiments, the obtaining information is accomplished by scrubbing text from the website 112 by a third-party. The “scrubbing” can be accomplished by obtaining information provided by the website owner or administrator, obtaining a snapshot of the website, or another method. The scrubbing can include obtaining links embedded in the text, determining links to other information, following the links to scrub additional information, and the like. The third-party information source can refer to a database locally owned but loaded with information from one or more third parties.

The flow 100 includes rendering a video about the products 120. Embodiments include rendering, by a video user interface, to a user, a video about the one or more products. The video can include a video stream, a short-form video, a livestream, a livestream replay, and so on. The video can be about a single product where information was fetched on that product as well as one or more other products. The video can include multimedia content such as audio and video, a soundtrack, a slideshow, text, images, and so on. The video is rendered by a video user interface. The rendered video is provided to a user. The video user interface can be based on an app such as a video player, an app developed to render a video about one or more products, a plug-in associated with a web browser, etc. The video player can be based on a general-purpose video app such as QuickTime™, VLC Media Player™, GOM Player™, and so on. The video user interface can comprise a video player in combination with a user interface. The video user interface can be downloaded from an app store such as the Apple™ App Store™, Google™ Play App Store™, and so on. The user interface can be enabled by downloading and installing an extension to a browser such as Chrome™, DuckDuckGo™ Edge™, Firefox™, Lycos™, Opera™, Safari™, Tor™, and the like. The video can be launched based on a selection by the user of a link, an image, a frame, an icon, a thumbnail, etc. on the website. A user can select a link on a website where the link can be associated with video about a product. The selecting of the link by the user can be accomplished by moving a cursor, clicking, tapping, etc. The video can be rendered along with a webpage. The rendering the video along with a webpage from the third party or other website can be accomplished without a popup window. By avoiding use of popup windows, a user can obtain information without the annoyance of the popup windows blocking views to parts or all of a screen associated with a device on which the video user interface is operating. No changes to popup blocker settings are required simply to view the rendered video. In some embodiments, the rendering and the fetching are accomplished on a same webpage. That is, the product information can be found, scraped, etc. from the same webpage in which the video is displayed.

In other embodiments, the rendering comprises a first video segment, wherein the first video segment includes a synthetic human. The synthetic human can be based on a generated image or an image of a live human captured from media sources including one or more photographs, videos, livestream events, and/or livestream replays. The synthetic human can be a representation of an animated character. The synthetic human can comprise a 360-degree representation. The synthetic human can operate within the video as a help desk representative, salesperson, livestream host, and so on. The voice of a human host can be recorded and included in the synthetic human representation. The first video segment can include the images and voice of the synthetic human, which can be generated, combined, edited, etc. by an artificial intelligence (AI) machine learning model into a 3D model that can be used to generate a video segment in which the synthetic human responds to the user request using answers generated by a large language model (LLM). For example, a first video segment including the synthetic human can be created, wherein the synthetic human is animated to say, “Hello. I see that you are looking at our universal cooking pot. What questions can I answer for you?” A game engine can be used to generate a series of animated movements, including basic actions such as sitting, standing, holding a product, presenting a video or photograph, describing an event, and so on. Specialized movements such as facial expressions can be programmed and added to the animation as needed. Dialogue can be added so that the face of the presenter moves appropriately as the words are spoken. Additional video segments can be produced. The first video segment and the additional video segments can be in response to a user question, gesture, interaction, text, etc. The result can be a performance by the synthetic human, combining animation generated by a game engine and the 3D model of the individual, including the voice of the individual.

The rendering can be based on one or more frames. A child frame can be launched, into which the webpage can be displayed. The child frame can be associated with a frame or “parent frame.” The child frame can be smaller than the parent frame. The small child frame can enable a picture-in-picture rendering of a video, a webpage, etc. The webpage can be an outer picture for the picture-within-picture function. The webpage, the video, and other web data can be rendered in the smaller frame, the larger frame, in more than one child frame, etc. The rendering the video can be an inner picture for the picture-within-picture function. The child frame can surround the video being rendered. The child frame surrounding the frame in which the video is being rendered can be used to provide webpage information, photos, additional video, etc. The video can be rendered at any position within the video user interface. For example, the video can be rendered in a lower right corner of a window containing the webpage. The lower right corner can be a default location, a configurable location, a user defined location, and so on. The webpage can be scrolled while the location of the video remains fixed. The user can scroll the webpage, click links on the webpage, etc. The scrolling can include scrolling up and down, scrolling left and right, and so on. The rendering can be accomplished using an inline frame function within an Internet browser application. The contents of the frame can be updated, changed, reloaded, etc., without affecting the Internet browser application.

The flow 100 includes interfacing between the user interface and the third party 130. Embodiments include interfacing between the video user interface and the third-party information source, wherein the interfacing is based on a user interaction with the video user interface. As a user watches a video, he/she may become interested in an object, such as a product that is shown. The user can interact with the video while it is playing. For example, a video can be played on a website that demonstrates a tennis player using a specific racket. The user can select the racket for additional details. Thus, in some embodiments, the interfacing comprises a request for the further information on an object based on the user interaction. The object can be a product for sale or another object within the video. The further information can comprise product information pertaining to a product that was selected, highlighted, etc. by the user. Discussed above and throughout, the information can include details about a product, availability of a product (e.g., in stock or out of stock), verified purchaser reviews, social media comments, etc.

The interfacing is based on a user interaction 132. The user interaction can include techniques used to manipulate computing devices, personal electronic devices, and the like. In some embodiments, the user interaction is accomplished by mousing over an object 134 in the video. The object can be a product for sale, a person, an activity, and so on. The mousing can be accomplished by moving a mouse device, by sliding across a touchpad, by swiping a digit such as a finger across a touchscreen, etc. For example, in order to indicate an interest in a product such as a pair of sneakers, the user interaction can comprise mousing over a person in the video (e.g., an object) that is wearing the sneakers. In other embodiments, the user interaction is accomplished by clicking on an object 136 in the video. The clicking can be accomplished by clicking a button associated with a mouse device, tapping or pressing a trackpad, tapping a touchscreen, and the like. For example, in order to indicate an interest in a product such as a pair of sneakers, the user interaction can comprise clicking on a person in the video (e.g., an object) that is wearing the sneakers. The interfacing between the video user interface and the third-party information source can include other operations, functions, etc. In some embodiments, the user interaction comprises showing interest in the product. The user can show interest by one of the methods described above, by texting, by typing text within the website, by asking a question, and so on. The website can include a chatbot, a text window, radio buttons, links to answers of frequency asked questions (FAQs), etc. which can capture user input to be used to fetch information (explained below) about a particular object, product, etc. within the video. In some embodiments, the interfacing comprises a purchase selection for an object. The purchase selection can be accomplished by clicking, tapping, etc., a product, a shop icon such as a shopping bag or a shopping cart. Discussed in detail below, the interfacing can include passing a callback function from the video user interface to the third-party information source based on the user interaction. The callback function can obtain information, dynamically add or remove product details, add a product to a shopping cart associated with the third party, and so on. The callback function can be updated based on what objects such as products are visible within the video at a given time. In order for information provided by the third party, such as information from a database, scrubbed from a website, etc. to be presented to the user by the video user interface, an interface can be used to obtain the information, to render the information on the device, and so on. The interfacing can be accomplished using function calls, an application programming interface (API), and so on.

The flow 100 include fetching product information 140. Embodiments include fetching product information associated with a product within the one or more products, wherein the fetching is based on the interfacing between the video user interface and the third-party information source. The fetching product information can include product details such as manufacturer, date of introduction, dimensions, cost, availability, delivery targets, and so on. The server can be associated with a manufacturer, an e-commerce site, etc. The server can include a social media server. The server can comprise a website, third-party website, etc. In some embodiments, the fetching is based on a user selection of the product within the one or more products. The fetching information can be initiated by a user interaction with the video user interface such as selecting a product by mousing, clicking, or tapping, as described above.

The flow 100 includes augmenting the video with further information 150. Embodiments include augmenting the video with further information based on the fetching of the product information associated with the product within the one or more products. The augmenting the video can include updating the video based on what products are visible at a given time, providing the additional product information, enhancing the video with product reviews, and so on. The augmenting can include overlaying the product information that was fetched over a portion of the video. The product information can be overlaid by including the information in a box, a circle, or other shape. The overlaying information can appear over an object; can appear over an object when the object is moused over, clicked, tapped; etc. The portion of the video can include a region of the video such as the lower right corner of the video. The augmenting can be based on a frame, a child frame, etc. The user can further select information, links, a purchase cart, etc. within the further information to gather additional product details, review the product, purchase the product, and so on.

The flow 100 includes determining objects in the video 160. Some embodiments include determining a plurality of objects within the video. The objects within the video can include items being used by a person (or synthetic person, as described earlier) within the video, items worn by the person, presented by the person, highlighted by the person, and so on. In a usage example, the determining a plurality of objects can include brand and color of clothing, accessories worn, devices used, items in an everyday carry, and the like. The plurality of objects can further include products being used by the person, promoted, or berated by the person, and so on.

Some embodiments include displaying information on each of the plurality of objects 170 within the video. A variety of techniques can be used to display the information on the objects. The information can be displayed by clicking on the object, hovering a cursor over the object, etc. In further embodiments, the displaying includes highlighting information 172 on a webpage for an object, based on the user interaction. The highlighting can be accomplished using techniques such as bolding text, underlining text, adding color, etc. In one or more embodiments, the displaying includes displaying information as an overlay 174 on the video. The overlay can include displaying the information in a shape such as a square, a circle, and so on. An opacity can be associated with the overlay so that the information does not completely obscure the object for which the information is being displayed. A user can select information within the overlay or the highlighting for any object. The selection can be accomplished by mousing, tapping, clicking, etc. The selecting within the overlay of highlighting can lead to additional information presented to the user.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

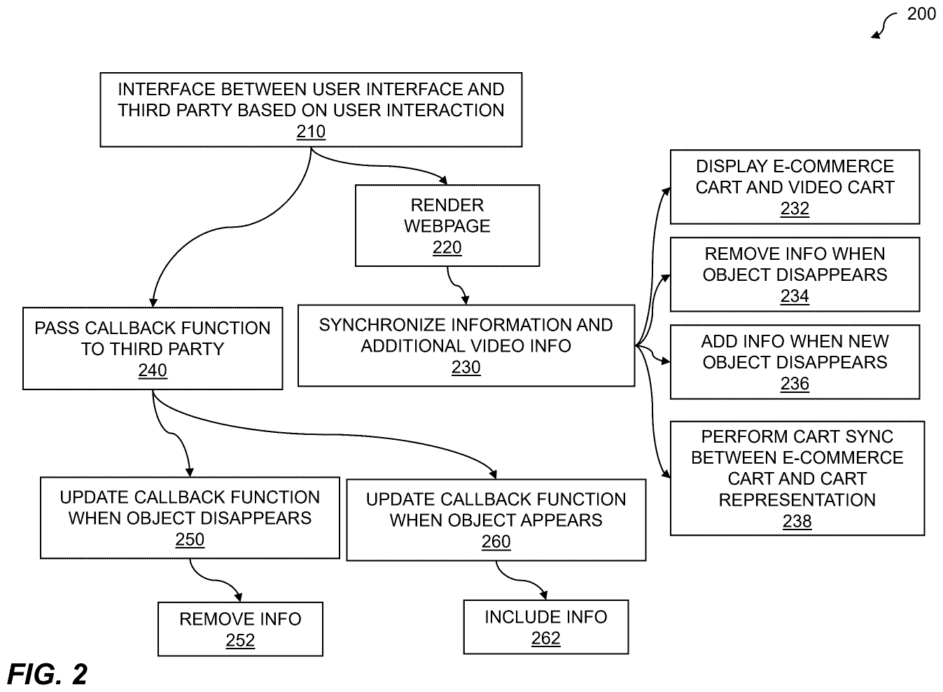

FIG. 2 is a flow diagram for cart rendering. Discussed above and throughout, a video can be rendered by a video user interface to a user. The video can include a livestream video, a video stream, a short-form video, and so on. The video can contain objects such as products that are being presented, discussed, offered for sale, and so on. The user to whom the video is rendered can interact with the video by selecting objects within the video. Selecting the objects can be used to fetch and provide information about the objects, to purchase the objects, etc. The selecting of an object can be accomplished by clicking, tapping, etc. a “shop” icon. The shop icon can be represented by a shopping bag, a shopping cart, a shopping basket, and so on. The shopping cart is enabled by the video stream interface based on third-party information. Information is obtained on one or more products from an information source by a third party. A video about the one or more products is rendered by a video user interface to a user. Product information is fetched from a server based on the interfacing between the video user interface and the third party. The video is augmented with further information based on the fetching.

The flow 200 includes interfacing between the video user interface and the third party based on a user interaction 210. Embodiments include interfacing between the video user interface and the third-party information source, wherein the interfacing is based on a user interaction with the video user interface. The user interaction with the video user interface can include computing device interactions, smart device interactions, touchscreen gestures, and so on. In some embodiments, the user interaction is accomplished by mousing over an object in the video. The mousing over can be accomplished by moving a cursor by means of a mouse device or a trackpad, by swiping over the object with a digit in contact with a touchscreen, and the like. In other embodiments, the user interaction is accomplished by clicking on an object in the video. The clicking can be accomplished by clicking a button associated with a mouse device, tapping a trackpad, tapping a touchscreen, etc. In one or more embodiments, the user interaction comprises showing interest in the product. The user can show interest by one of the methods described above, by texting, by typing text within the website, by asking a question, and so on. The website can include a chatbot, a text window, radio buttons, links to answers of frequency asked questions (FAQs), etc. which can capture user input to be used to fetch information (explained below) about a particular object, product, etc. within the video.

The flow 200 includes rendering a webpage 220. Some embodiments include rendering a webpage based on the user interaction. The webpage can include a product webpage, a webpage that includes a video about the product, and so on. The rendering can be based on a video frame (e.g., rendered within the video), rendered within the video interface, based on launching a new web browser page, and so on. The flow 200 includes synchronizing information on the webpage with additional information 230 shown on the video. The video can show a single object such as a single product or service, can compare products or services, can include a plurality of goods or services, and so on. The synchronizing can be based on a user interaction. In a usage example, a user interacts with the video user interface by selecting a product. The synchronizing can include jumping to a portion of the webpage that presents information on the product, zooming in on the product, and the like.

In some embodiments, the synchronizing includes displaying e-commerce shopping cart information on the webpage and video shopping cart information shown on the video 232. The shop icon such as a shopping bag or shopping cart that can appear within the video rendered in the video user interface can be used to access an e-commerce shopping cart.

By clicking on the cart icon in the video user interface, the user can view the contents of the e-commerce cart. Mentioned above and throughout, a plurality of objects such as products can be included in website content. Since the number of objects can easily exceed the number of objects that can reasonably be displayed via the video user interface at a given time, the user can scroll through a list of objects such as products, swipe through pages of objects, and so on. As a result, objects can appear and disappear within a particular view of the objects. In some embodiments, the synchronizing includes removing information on an object when the object disappears 234 from view on the video. The object that has disappeared from view cannot be selected within the current view, so information associated with the object which is no longer visible can be removed. Other objects can come into view while objects disappear from view. In some embodiments, the synchronizing includes adding information on a new object in an associated webpage when the new object appears 236 on the video. The new object can be selected by tapping the object, adding the object to a cart, and so on. Selecting the new object can enable fetching of information associated with the new object that has come into view. Some other embodiments include performing cart synchronization between an e-commerce shopping cart on the webpage and a cart representation 238 displayed over a portion of the video. The shop icon in the video user interface can represent a generic shopping cart that can be coupled temporarily to an e-commerce shopping cart associated with website content rendered in the video user interface. Thus, when a user selects a product by tapping or clicking the shop icon within the video user interface, the product of interest can be added to the shopping cart on the e-commerce site. The addition of the product of interest to the e-commerce shopping cart can be accomplished by the synchronizing.

The flow 200 includes passing a callback function to a third party 240. In some embodiments, the interfacing comprises passing a callback function from the video user interface to the third-party information source. A callback function can include a function that is accessible to a second function. The callback function can be provided as an argument to the second function. The callback function can be executed following completion of the function to which the callback function is provided. The callback function can include a JavaScript™ callback function. The callback function can be updated when the object disappears 250. Some embodiments include updating the callback function when an object disappears from view on the video and the augmenting updates to remove information 252 on the object that disappears. The user can no longer interact with an object that has disappeared from view, so information associated with the object, references to the object, and so on are no longer needed. The callback function can be updated accordingly. The object can comprise a product for sale. For example, in response to a user interaction, product information about a chair can be shown within the video while the chair is also in the video. When the chair is no longer in the video, the product information can be removed. The callback function can also be updated when the object appears 260. Some embodiments include updating the callback function when an object appears in view on the video and the augmenting includes information 262 on the object that appears in view. Information associated with each object that comes into view is obtained and provided to the user. The callback function can be updated to reflect the objects that have come into view. The information can be fetched from a server that can provide information on the one or more objects that have appeared in view. For example, based on user input, product information can be highlighted for a frying pan while the video shows a chef using the pan. Later, the video may jump to a scene where the chef uses a pressure cooker. Accordingly, the product information can be updated to represent the pressure cooker. At any time, the user may mouse over, click on, or otherwise show interest in some object in the video and the information can switch to the object indicated.

In some embodiments, the callback function is based on the user interaction. The user interaction can comprise a purchase action. For example, a user can see a product in which she or he is interested. The user can place the product into a shopping cart by tapping the shopping cart or shopping bag icon rendered by the video player. In contrast to performing purchasing tasks within the video player on the device, the purchase request is provided to a third-party webpage through the user interface. Thus, the purchase can be executed by the native webpage. In some embodiments, the interfacing comprises passing a callback function, as an argument to a second function, from the video user interface to the third-party based information source on the user interaction, and wherein the callback function is updated to augment information based on changes in product visibility as a result of the product from the one or more products disappearing from view on the video. In further embodiments, the augmenting is based on the product visibility as a result of the product from the one or more products disappearing from view.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

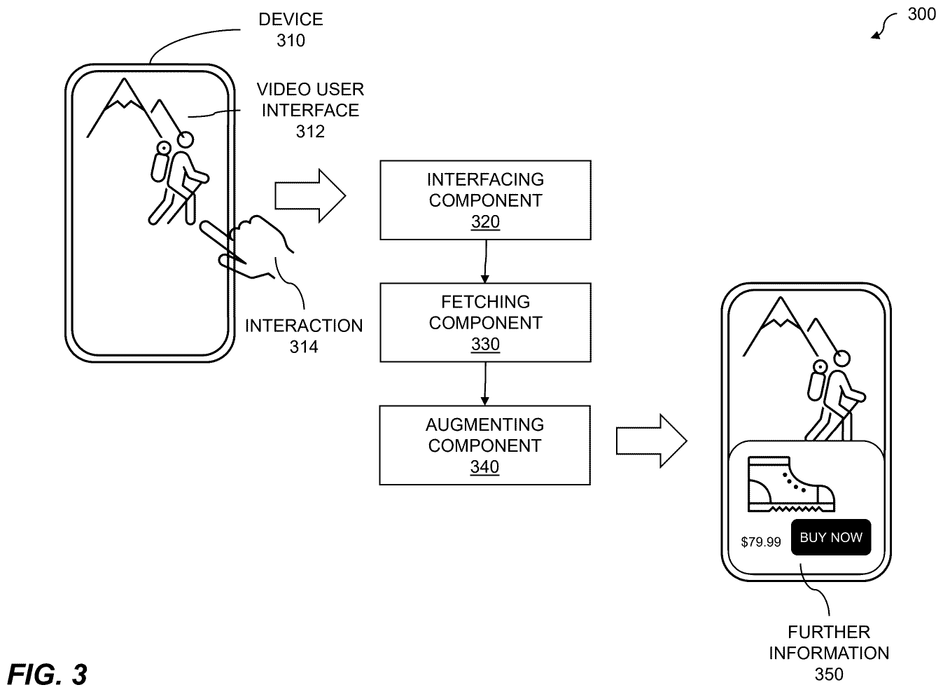

FIG. 3 is an infographic for augmenting a video. A video can be rendered on a device 310. As described above, the device can comprise any compute device on which a video can be viewed, such as a desktop computer, a laptop computer, a tablet, a smartphone, a personal digital assistant (PDA), and so on. The device can include a video user interface 312. The video user interface can be based on an app such as a video player, an app developed to render a video about one or more products, a plug-in associated with a web browser, etc. The video player can be based on a general-purpose video app such as QuickTime™, VLC Media Player™, GOM Player™, and so on. The video user interface can comprise a video player in combination with a user interface. The user interface can be enabled by downloading and installing an extension to a browser on the device. The video user interface can show a video. The video can be launched based on a selection by the user of a link, an image, a frame, an icon, a thumbnail, etc. on the website. A user can select a link on a website where the link can be associated with video about a product. The selecting of the link by the user can be accomplished by moving a cursor, clicking, tapping, etc. The video can be rendered along with a webpage. The video can comprise a short-form video, livestream, livestream replay, or any other type of video. The user can interact 314 with the video. In some embodiments, the user interaction is accomplished by mousing over an object in the video. In other embodiments, the user interaction is accomplished by clicking on an object in the video. In one or more embodiments, the user interaction comprises showing interest in the product.

The infographic 300 shows a user touching the foot of a hiker within a video playing in the video user interface. The user interaction with the video can trigger an interfacing component 320. Embodiments include interfacing between the video user interface and the third-party information source, wherein the interfacing is based on a user interaction with the video user interface. In the infographic 300, the touching of the foot of a hiker can cause the interfacing component to communicate with a third-party information source such as a database, a website, a file, etc. The third-party information source can include information on an object, product, activity, etc. within the video. In the infographic 300, the third-party information source can include details on the footwear that the hiker is wearing within the video.

The information from the third-party source can be fetched 330. Embodiments include fetching product information associated with a product within the one or more products, wherein the fetching is based on the interfacing between the video user interface and the third-party information source. The fetching can retrieve any number of details about the object that was selected. The details can comprise product information. For example, the product information can include manufacturer, date of introduction, dimensions, price, promotions, availability, colors, styles, reviews, delivery details, and so on.

The video can be augmented 340 with the product details that were fetched from the third-party source. Embodiments include augmenting the video with further information based on the fetching of the product information associated with the product within the one or more products. The augmenting can include overlaying the product information that was fetched over a portion of the video. The product information can be overlaid by including the information in a box, a circle, or other shape. The overlaying information can appear over an object; can appear over an object when the object is moused over, clicked, tapped; etc. The portion of the video can include a region of the video such as the lower right corner of the video. The augmenting can be based on a frame, a child frame, etc. The user can further select information, links, a purchase cart, etc. within the further information to gather additional product details, review the product, purchase the product, and so on. In the infographic 300, the further information 350 shown includes a picture of boots that the hiker in the video is wearing, a price and a “buy now” button, which can launch an ecommerce transaction.

The information that is displayed can be updated as objects appear and disappear within the video. For example, if the hiker is no longer shown in the video, the product information regarding the boots can be removed. This operation can be achieved via a callback function such as a JavaScript™ callback function or another type of function. In some embodiments, the interfacing comprises passing a callback function from the video user interface to the third-party information source. Further embodiments include updating the callback function when an object disappears from view on the video and the augmenting updates to remove information on the object that disappears. When another product appears in the video, new information can be presented. One or more embodiments includes updating the callback function when an object appears in view on the video and the augmenting includes information on the object that appears in view. The updating can be based on a user interaction with the product that comes into view. As described earlier, in some embodiments, the callback function is based on the user interaction.

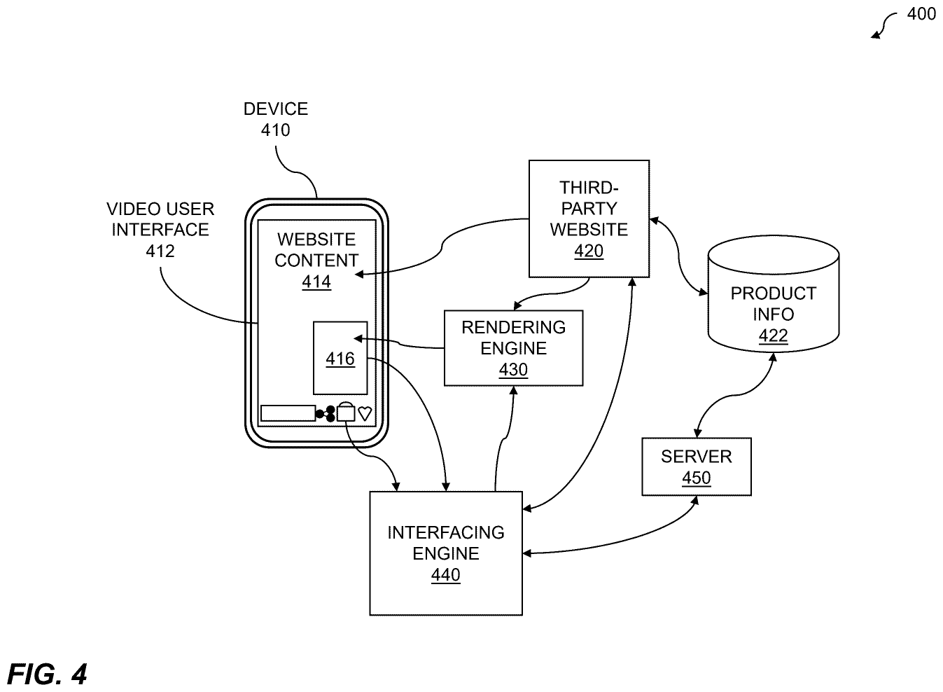

FIG. 4 shows a system block diagram for a video stream interface. A video stream interface can be used to present a video stream to a user based on information obtained from a third-party information source, such as a website. The video stream interface can further support interaction between the user and the video stream, where the interaction can include selecting objects such as a product that appears within the video stream. The video stream interface is based on third-party information. Information is obtained on one or more products. A video about the one or more products is rendered by a video user interface to a user. The video user interface and the third-party information source are interfaced between each other based on a user interaction with the video user interface. Product information is fetched from a server based on the interfacing between the video user interface and the third-party information source. The video is augmented with further information based on the fetching.

The system block diagram 400 can include a device 410. The device can include a computing device such as a desktop computer or laptop computer; a personal electronic device such as a smartphone, PDA, or tablet; a video player device; and so on. The device can be used by a user to access content such as web content, where the web content can include text, video files, audio files, and the like. A video user interface 412 can be associated with the device. The video user interface can include a display component with which a user can view content such as video content. The video user interface can further include an interaction component. The interaction component can be used to determine interactions between a user of the interface and contents rendered in the video user interface. The video user interface can be based on an app such as a video player app. The video user interface can display content within a window or frame associated with the video user interface. Various types of content can be displayed using the video user interface. The content can include website content 414. The website content can be obtained from a website (discussed shortly). The website content can include a video in which one or more products are included. The video user interface can further include a rendering component. The rendering component can be used to render a video about the one or more products. The user can interact with the products within the video. The interacting can be used to fetch further information about the one or more products.

The system block diagram 400 can include a third-party website 420 as the third-party information source. The third-party website can present of wide range of information such as political messages, educational materials, public service announcements, travel services, etc. The information can include videos such as livestream videos, video streams, short-form videos, and so on. The information can further include text and audio files, links to other webpages and websites, etc. The information can be rendered in a window or frame associated with the video user interface. The website information can include product information 422 for one or more products. The product information can include one or more products that can be seen in the content of the third-party website. The system block diagram 400 can include a rendering engine 430. The rendering engine can be used to render information about the one or more products. The product information can include one or more videos associated with the one or more products. The rendering to a user can be accomplished by the video user interface within a window, a frame, and so on, such as frame 416.

The user can interact with the video user interface. The interacting can include common actions, gestures, and so on utilized by a user as they interact with a device such as a personal electronic device. In some embodiments, the user interaction can be accomplished by mousing over an object in the video. The mousing can in turn be accomplished by moving a cursor with a mouse device, sliding a digit over a trackpad, and the like. In other embodiments, the user interaction can be accomplished by clicking on an object in the video. The clicking can include clicking a button on a mouse device, tapping a trackpad, etc. In further embodiments, the interfacing can include a request for the further information on an object, based on the user interaction. An object can include a product or service, an item used by a person present in the website content, an item presented by the person, and the like. The further information can describe the object, present pricing information associated with the object, etc. The interacting can be used by an interfacing engine 440. The interfacing engine can interface between the video user interface and the third-party information source with which the third-party website can be associated. The interfacing engine can detect user interactions with the video user interface, the type of interaction, and so on. The interactions can include tapping, clicking, or selecting objects rendered in the video user interface as described above. The interactions can also include selecting an object using a “shop” icon rendered within the video user interface. The shop icon can be rendered as a shopping bag, a shopping cart, and so on. The selecting an object, adding an object using a shop icon, etc., can include a request for information such as product information associated with the object. The request for information about a product can be accomplished by a server 450. The server can fetch the product information 422 associated with the third-party website 420. The server can provide the fetching information to the interfacing engine. In embodiments, further information based on the fetching can be used to augment the video. The augmenting can be accomplished by the rendering engine 430.

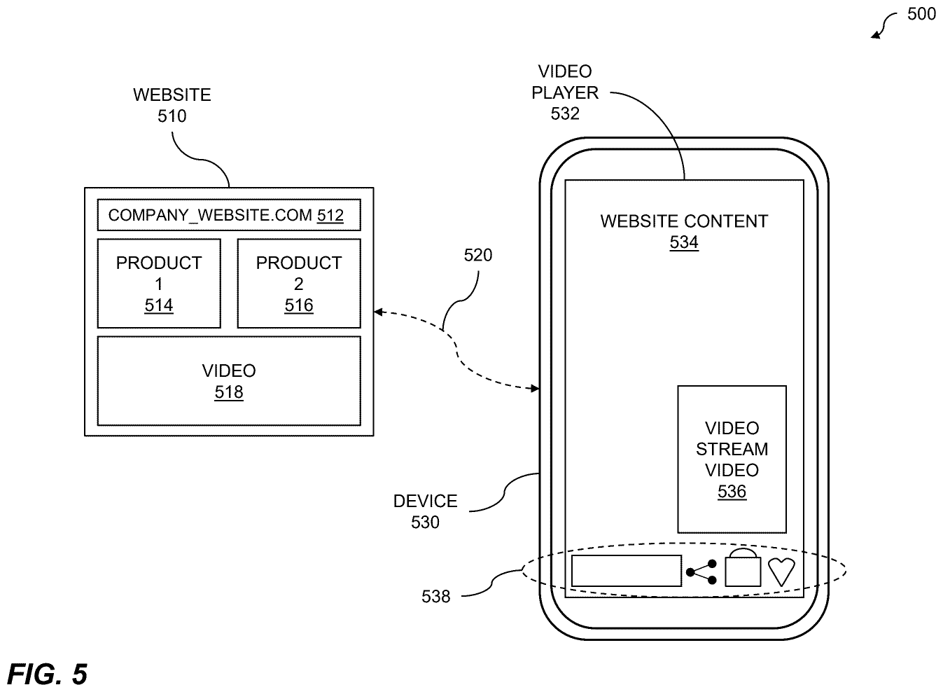

FIG. 5 illustrates webpage information and a video stream on a device. A user can view a video, where the video can include a livestream video, a video stream, a short-form video, and so on. The video can include products, services, and so on that can be promoted by a provider of the videos. The livestream videos and other videos, which can include videos presented by celebrities, tastemakers, influencers, and so on, can mention, promote, endorse, highlight, or otherwise present one or more products. The products can be available for purchase on a website. A user can learn more about the products, purchase the products, etc., by clicking on the products within a video. Rendering of the webpage and video stream on a device such as a personal electronic device is enabled by a video stream interface based on third-party information. Information is obtained on one or more products from a third-party information source such as a website, database, etc. A video about the one or more products is rendered by a video user interface. The rendering is provided to a user. Interfacing between the video user interface and the third-party information source is provided based on a user interaction with the video user interface. Product information is fetched from a server based on the interfacing between the video user interface and the third party. The video is augmented with further information based on the fetching.

Webpage information and a video stream rendered on a device are illustrated 500. The webpage can be associated with a website 510, which can include text, one or more videos, one or more audio files, and so on. The website is accessible by providing a universal resource locator (URL) address 512. To access the website, one enters the URL into a web browser such as Chrome™, Edge™, Firefox™, Opera™, Safari™, etc. The contents of the webpage can include information associated with one or more products such as product 1 514, product 2 516, and so on. While two products are shown, other numbers of products can be included on the webpage, webpages accessible through the webpage, etc. The contents of the webpage can further include livestream video 518. The livestream video can demonstrate the one or more products, can endorse products, can instruct users in the use of the products, and so on. The contents of the webpage can include other videos such as short-form videos, livestream replays, and so on.

The contents of the one or more webpages associated with the website 510 can be provided to a device 530 via a connection 520 such as a network connection. The connection 520 can include a wireless connection such as a Wi-Fi™, Bluetooth™, or cellular connection; a wired connection such as an Ethernet™ connection; and so on. An app such as a video player app 532 can be executed on the device in order to display website content 534. The website content can be rendered to a user by a video user interface. The video user interface can be used to display a video about one or more products associated with the website 510. The video player can also be used to render a video stream video 536. The video stream video can include a livestream video, a video stream, a short-form video, and so on. The video stream video can include information about one or more products associated with the website. The one or more products within the video stream video can be selectable by the user in order to obtain further information about the one or more products. Icons 538 associated with the website can also be rendered by the video player. The icons can include one or more icons such as online vending, social media, and so on. In embodiments, the icons can include a chat box, a sharing icon, a shop icon such as a bag or cart, a “like” icon, etc. The icons can be used to purchase one or more products, discuss the products, provide links to other or similar products, and so on.

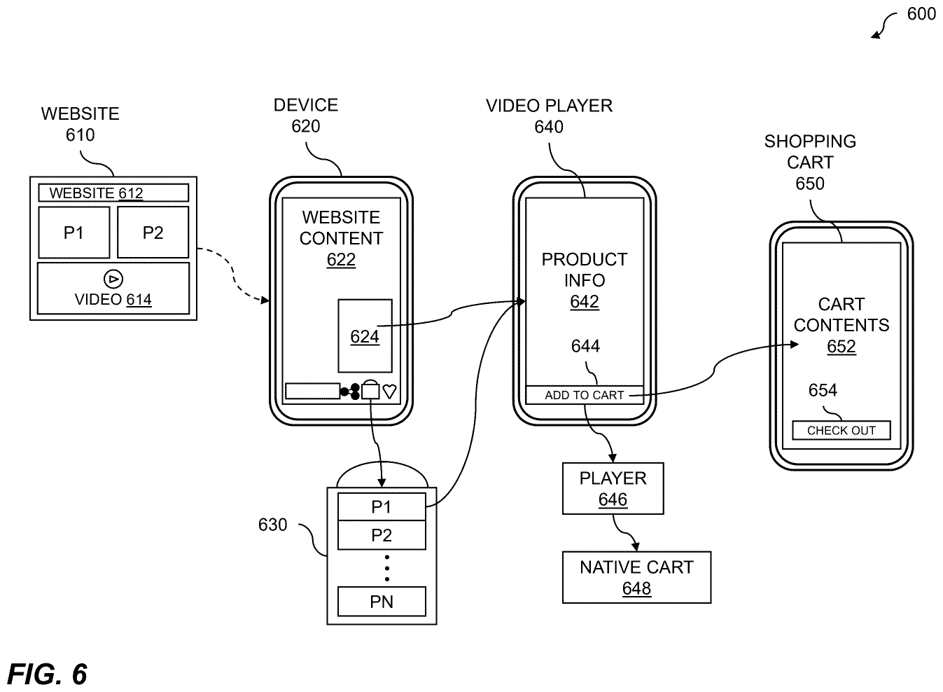

FIG. 6 is a system block diagram for an add-to-cart operation 600. A user can view a video in which a product is introduced, promoted, endorsed, and so on. The user can choose to learn more about the product and if interested, can add the product to a shopping bag or cart in order to purchase the product. The user can learn about the product, can purchase the product, etc., without leaving the video that contains the product. Instead, the video can continue to play while the user is learning more about the product, purchasing the product etc. The add-to-cart operation can be accomplished by clicking on a shop icon or by interacting with the product within the video. The interacting can include tapping, clicking, swiping, and the like. The add-to-cart operation is enabled by a video stream interface based on third-party webpage information. Information on products is obtained from a third-party information source. A video about the products is rendered to the user by a video user interface. The video user interface and the third-party information source are interfaced between each other based on a user interaction with the video user interface. The video is augmented with further information based on the fetching.

A website 610 can include information associated with one or more products. The website can be accessible using a uniform resource locator (URL) or “web address” 612. The URL can be input to a web browser to access the website. The website can include text, videos, audio files, and other content. The website can include product information associated with one or more products such as product P1 and product P2. The website can include video content such as video 614. The video can include livestream video, a video stream, a short-form video, and the like. A device 620 can be used to display website content 622. The device can include a hand-held electronic device, a portable electronic device, a desktop electronic device, and so on. In addition to the website content, a video 624 can be rendered. The video can include product information and other information. The user who is viewing the website content and the video can choose to learn more about one or more products. As described above and throughout, the user can learn more about the products by interacting with the video such as mousing over a product, clicking a product, etc. The user can also learn more about the product via a shop icon such as a bag or cart icon, by tapping on a product presented in the video 624, etc. Interacting with the shop icon can add the product to a shopping bag 630, a shopping cart, and so on. The shopping bag or cart can include one or more products such as product P1, product P2, product PN and so on. The user can select a product such as product P1 to obtain information associated with the product.

A video player 640 can be used to render product information 642 for a product selected within the video 624 or added to the shopping bag 630. The product information can present details associated with the product such as size, color, price, availability, shipping and other costs, configuration information, and so on. A user can choose to select the product for purchase by interacting with a shop icon such as an “Add To Cart” icon 644. Interaction with the shop icon can be detected by the video player 646. The video player can configure the shop information into a suitable format and can provide the formatted shop information to a native cart 648 associated with the website 610. Further, interaction by the user with the shop icon can enable display of a shopping cart 650 on the device 620 with which the user is interacting. Cart contents 652 can include one or more products that the user wishes to purchase. When the user is ready purchase, the user can indicate this by tapping, clicking, etc. on an icon such as a “Check Out” icon 654. The user can then be directed to a payment site, where the payment site can be associated with the website 610.

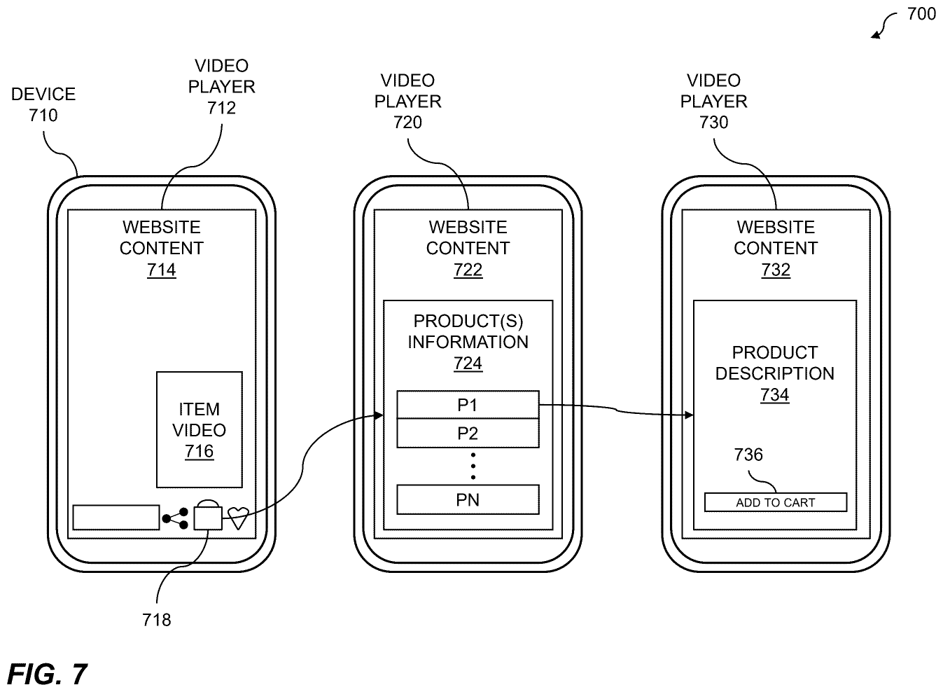

FIG. 7 illustrates providing product information via a shop icon. A user can view a video, where the video can include a livestream video, a video stream, a short-form video, and so on. The user may be interested in a product presented within the video and may wish to purchase the product. One of the ways the user can be presented with information associated with the product is by tapping, clicking, etc. the “shop” icon, such as a shopping bag, a shopping cart, and so on. The information is obtained using a video stream interface based on third-party information. Information is obtained on one or more products from a third-party information source. A video about the one or more products is rendered to the user by a video user interface. The video user interface and the third-party information source are interfaced between each other based on a user interaction with the video user interface. Product information is fetched from a server based on the interfacing between the video user interface and the third-party information source. The video is augmented with further information based on the fetching.

Providing product information via a shop icon to a user is illustrated 700. A device 710 associated with a user can provide product information to the user using a video player 712. The device can include a personal electronic device, a computer, and so on. The video player can include a video stream player or other video player. Website content 714 obtained from a website associated with a third party can be provided to a user associated with the device. The website content can include text, video, audio, etc. An item video 716 can also be presented to the user. The item video can include video associated with a product that can be included within the website content. In addition to the website content, a “shop” icon 718 can be included. The shop icon can be represented by a bag, a cart, and so on. A user who wants to learn more about a product seen in the website content can click, tap, or otherwise interact with the shop icon.

The video player 720 can continue to play a video associated with the website content 722. User interaction with the shop icon 718 can cause a window, a frame, etc. to open over the website content. The window, frame, and the like can include product information 724 associated with one or more products shown within the website content. The one or more products can include products such as product P1, product P2, product PN, and so on. The user can interact with a product rendered within the product information frame by tapping, clicking, swiping, etc. The video player 730 can continue to play the video associated with the website content 732. A product description 734 can be displayed within a window, a frame, and the like. The product description can include detailed information such as size, color, availability, etc. If interested in the product, the user can tap, click, etc. an “Add To Cart” icon 736. If the user instead wants to obtain a product description associated with a different product, the different product can be selected. The product description 734 can be updated to present the description associated with the different product. When the user locates the product in which she or he is interested, they can select the “Add To Cart” icon.

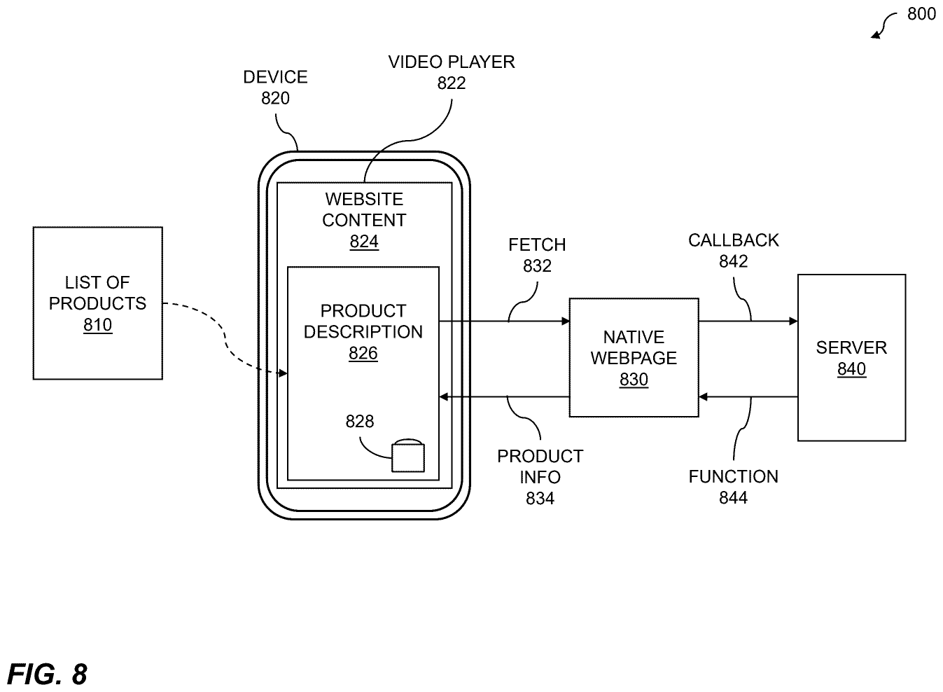

FIG. 8 shows product hydration. Product “hydration” can include obtaining information about a product from a third-party information source. The product information can include product options such as size and color, product availability, product cost, shipping and handling charges, and so on. The product information can be obtained from a native webpage associated with a third-party website. The product information can be presented on a device associated with a user by rendering the product information in a video player. The user can then interact with the product information rendered in the video player. Product hydration is enabled by a video stream interface based on third-party information. Information on one or more products from a third party is obtained. A video user interface is used to render a video about the one or more products to a user. An interface is established between the video user interface and the third-party information source based on a user interaction with the video user interface. Product information is fetched from a server based on the interfacing between the video user interface and the third party. The video is augmented with further information based on the fetching.

Product hydration is shown 800. A list of products 810 can be rendered on a device 820 using a video player 822. The list of products can include one or more products presented, discussed, etc. within a video. The device can include a smartphone, PDA, tablet, laptop computer, desktop computer, and so on. The video player can include a video app, a video plug-in associated with a web browser, a purpose-built video app, and the like. A product description 826 can be presented. The product description can be associated with one or more products. The presenting of the product description can be accomplished within a frame of website content 824. The user can interact with the product information. Interacting with the product information can include adding the product to a shopping bag 828, a shopping cart, and so on, using a shop icon. The product information can be obtained or “scrubbed” from a native webpage 830 associated with the product. The product information can be retrieved from a database on another suitable storage medium. A request or fetch 832 can be issued from the device based on a user interaction with a product within the product description. Product information 834 can be provided to the video player and rendered for the user. The native webpage is enabled by a server 840. A callback 842, a request for information, and so on can be sent to the server. The server can execute the information request based on a function. The function 844 can return results via the native webpage to the video player. In a usage example, a user can see a product in which she or he is interested. The user can place the product into a shopping cart by tapping the shopping cart or shopping bag icon rendered by the video player. In contrast to performing purchasing tasks within the video player on the device, the purchase request is provided to the third-party webpage through the user interface. Thus, the purchase can be executed by the native webpage.

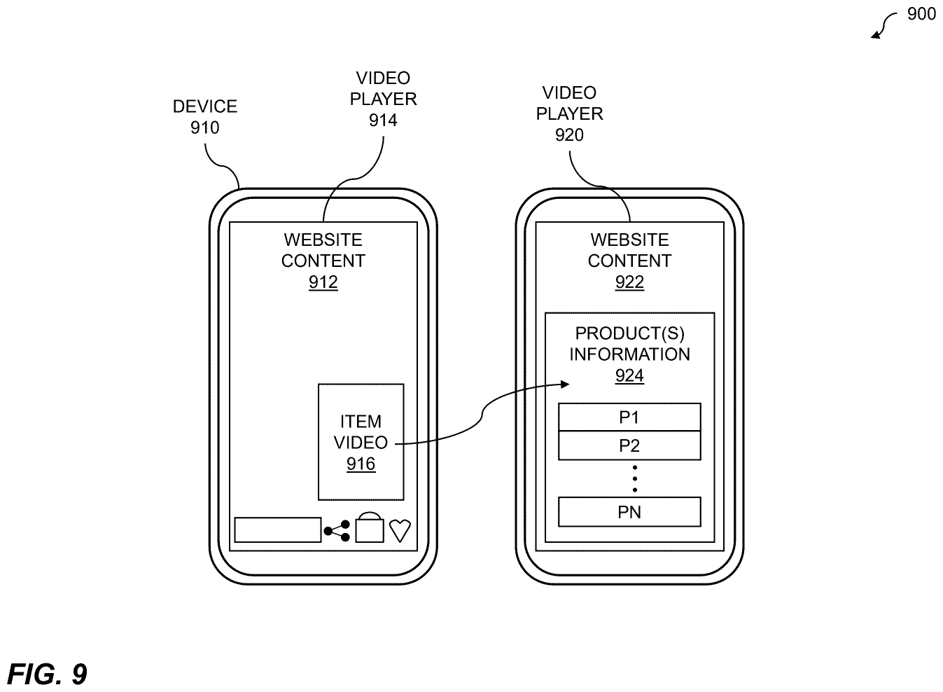

FIG. 9 illustrates delivering product information via a video stream. A user can view a video stream in which one or more of a variety of products can be displayed. The products can be associated with information scrubbed from a third-party webpage. The user may be interested in obtaining further information related to one or more of the products. By interacting with a video user interface, the user can indicate a product of interest and can be presented with information associated with the product of interest. The interacting with the user interface can be based on familiar interactions such as moving a cursor, tapping, clicking, and so on. A video stream interface based on third-party information enables delivery of product information via a video stream. Information on one or more products is obtained from a third-party information source. A video about the one or more products is rendered by a video user interface to a user. The video user interface and the third-party information source are interfaced between each other based on a user interaction with the video user interface. Product information is fetched from a server based on the interfacing between the video user interface and the third-party information source. The video is augmented with further information based on the fetching.

An example showing delivery of product information via video stream is illustrated 900. The video stream can be rendered on a device 910. The device can include a handheld device such as a smartphone, PDA, or tablet: a portable device such as a laptop computer; a desktop computer; and so on. The product information, which can be obtained or “scrubbed” by accessing website content 912 from a third-party website, can be delivered as video to the device using a video player 914. The video can include a livestream video, a video stream, a short-form video, and so on. The video can include a product presentation, a tastemaker or influencer talking about their favorite product, and so on. An item video 916 can include video about the favorite product. In a usage example, an influencer can be discussing her or his favorite product such as a smartphone case. While they are doing that, the item video can present information about the smartphone case. The information can include different sizes for different smartphone models, color selections available, additional features such as card carriers or charging interfaces, and the like. A user viewing the product presentation can swipe, tap, click, or otherwise interact with the item video to indicate that further information about the item within the video is desired. Interacting with the item video can cause a window, frame, or the like to open over the website content to present the requested information. The video player 920 can continue to present the website content 922 just described. A frame 924, window, etc. can open over a portion of the website content. A plurality of products such as products P1, P2, and PN can be presented within the frame. The user can scroll through the products, make a selection, and so on. The user can interact with the third-party website that offers the products simply by interacting with the products within the product information frame. Interacting can include obtaining further information, placing a product in a shopping cart associated with the third-party website, saving the product for later, purchasing the product, and the like.

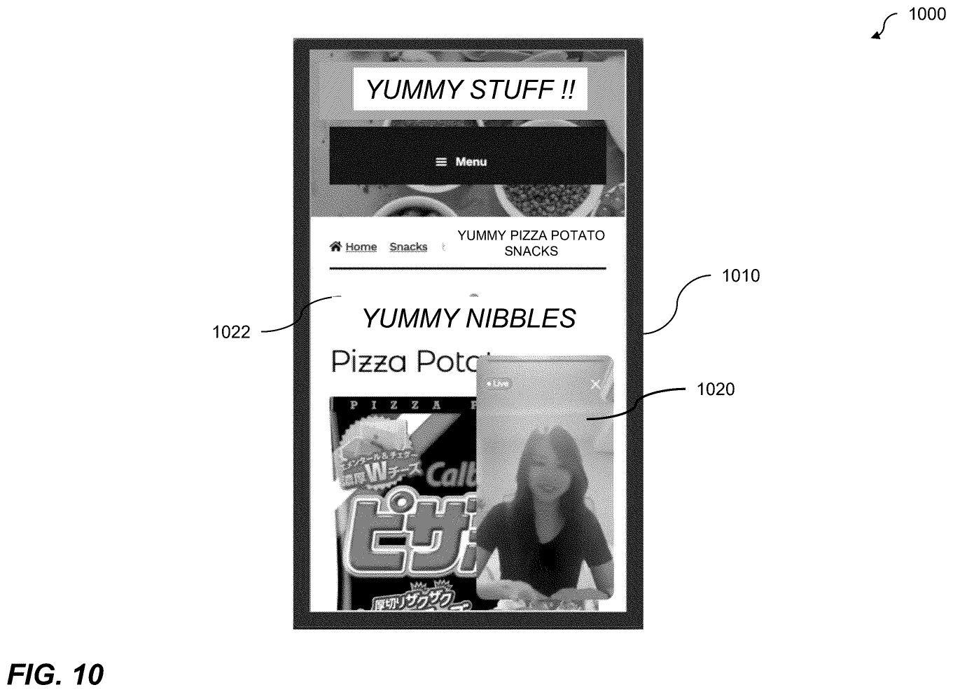

FIG. 10 is an example that shows a reduced video in a child frame, along with webpage information. The webpage information can be included within a child frame. A user can experience a video stream by viewing the stream on an electronic device such as a computer or personal electronic device. The video stream can be viewed using an app such as a video app, a window associated with a web browser, and so on. The individual who is experiencing a video stream video can click website information associated with the video stream. The website information can include product information. The video can be rendered, along with the information scrubbed from a third-party website. The video can be reduced to render the reduced video in a frame on a portion of the device display. The results of the link can be rendered within a child frame on the device display. The results of the link can include a webpage. Video and webpage rendering are enabled using a frame and a child frame. The frame and the child frame enable a video stream interface.

An example of a reduced video and website content is shown 1000. The reduced video and the website content can be rendered on a display 1010, where the rendering can be accomplished using an app, a browser window, and so on. In embodiments, the rendering is accomplished using a video stream interface. The video stream video can be reduced so that the video can be rendered in a portion of the app or browser window along with results of the selected link. The video 1020 can be rendered within a frame. The frame can enable viewing of the video stream video; pausing, playing, and stopping the video; and the like. In embodiments, the reducing the video to render the video in a portion of the app or browser window can include launching a third-party webpage 1022 to render the video superimposed over the third-party webpage. The website content can be rendered in a child frame. The reduced window can be rendered at various locations within the app or browser window. In embodiments, the reducing can cause the video to be rendered in a lower right corner of the app or browser window. The location of the reduced video can be fixed, predefined, user defined, and so on. Embodiments can include modifying location for the rendering. The modifying can include clicking on a grid, choosing a menu option, and the like. In embodiments, the modifying location can be in response to a mouse or trackpad dragging motion by the user.

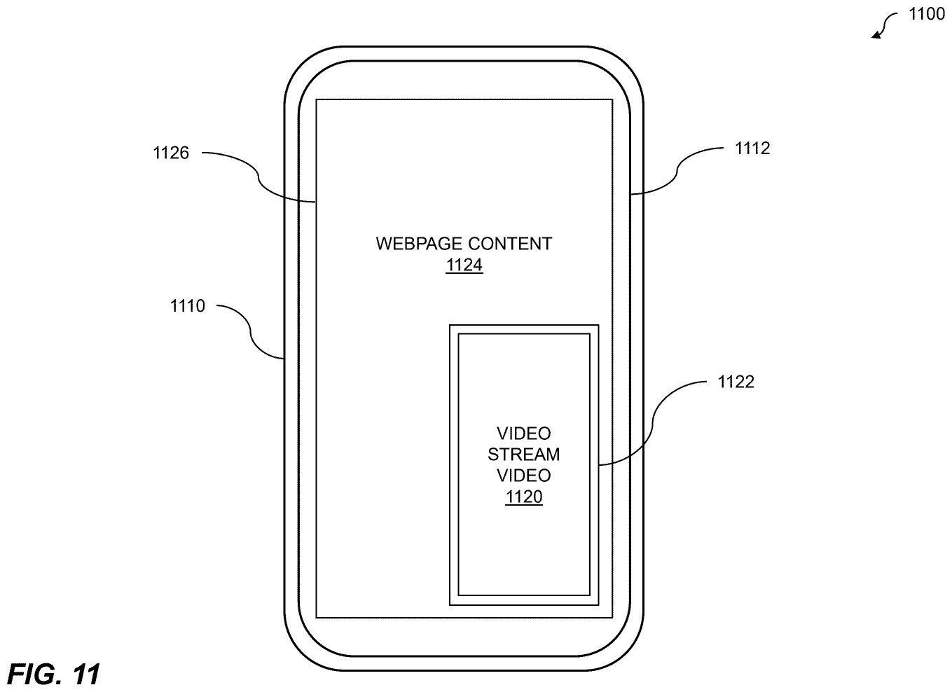

FIG. 11 illustrates a representation of a video stream and website content. Video stream video and website content obtained for an individual can be rendered within a frame and one or more child frames. The frame and a child frame can be used for video and webpage rendering, where the webpage can include product information. Information on one or more products is obtained from a third-party information source. A video about the one or more products is rendered by a video user interface to a user. The video user interface and the third-party information source are interfaced between each other based on a user interaction with the video user interface. Product information is fetched from a server based on the interfacing between the video user interface and the third-party information source. The video is augmented with further information based on the fetching. An example video stream video and third-party webpage information are shown 1100. The video, and the webpage information, which can include product information, can be rendered within an application or app, a window associated with a web browser, and the like. An app or a web browser can be executed on an electronic device 1110. The rendering can be accomplished on a display 1112 associated with the electronic device. The electronic device can include a computer, a laptop computer, a smartphone, a tablet, a PDA, and so on. The rendering of a video stream video 1120 can be accomplished using a frame 1122. The frame can occupy a portion of the display. The frame can include a frame within an app, a frame within a browser window, etc. In embodiments, the rendering the reduced video and webpage content is accomplished without a popup window. The webpage content 1124 can be rendered within a child frame 1126. In a usage example, the webpage content can include one or more of a product, a service, a coupon, or a membership. Embodiments include launching a child frame into which the webpage is displayed. The child frame 1126 can be larger than the parent frame 1122. In embodiments, the child frame surrounds the video being rendered.

The location of the reduced video 1120 within the frame 1122 can include a corner, the center, and so on. The reduced video can be resized, moved, expanded, shrunk, and so on. The results from the link, such as a third-party webpage, can be scrolled to enable viewing of content of the third-party webpage. The reducing the video to render the video, in a portion of the window along with the third-party webpage, can result in the video being rendered such that it remains fixed in the browser window while the third-party webpage is scrolled. The reduced video can play while the third-party website is scrolled. Content presented on the third-party website can be selected for viewing, watching, listening, reading, and so on. In embodiments, the rendering the video can accomplish a picture-within-picture function. The reduced video can be accompanied with one or more options to select further content. The further content can include videos, images, text, audio, and so on. The further content can comprise a webpage. The further content can be rendered. In embodiments, the rendering the video can accomplish a page-within-page function.

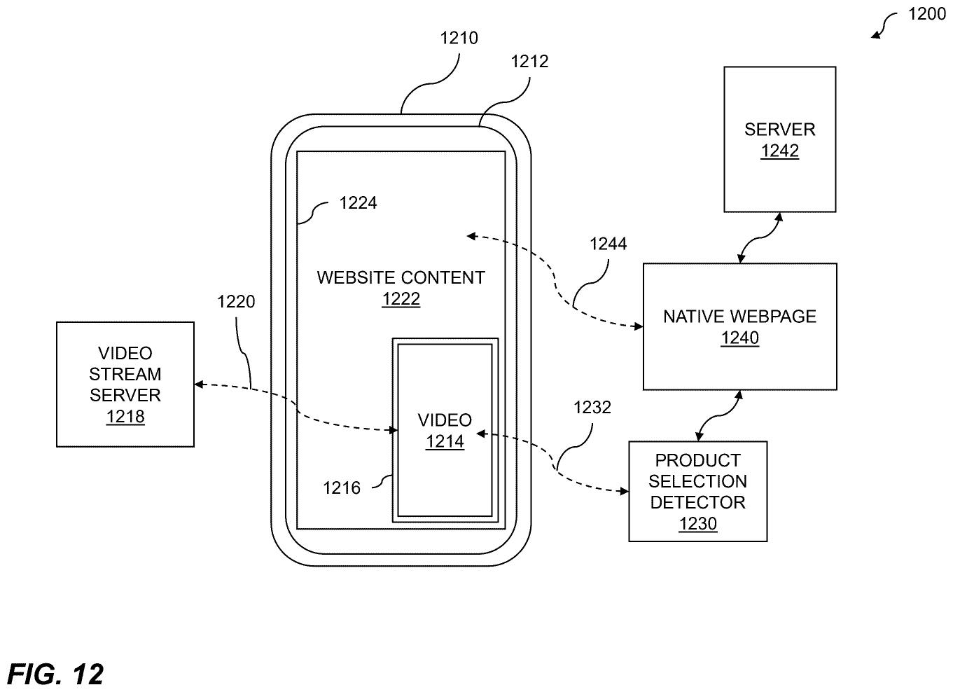

FIG. 12 is a system block diagram 1200 for video and webpage rendering. A video such as a livestream video, video stream, or short-form video, and contents of a website such as a third-party website, can be rendered on a display associated with a computer, a personal electronic device, and so on. The rendering can be based on the use of a frame and one or more child frames for displaying the video and the results of the link. A video stream interface based on third-party webpage information is enabled by the frame and the child frame. Information on one or more products is obtained from a third-party information source. A video about the one or more products is rendered by a video user interface to a user. The video user interface and the third-party information source are interfaced between each other partly based on a user interaction with the video user interface. Product information is fetched from a server based on the interfacing between the video user interface and the third-party information source. The video is augmented with further information based on the fetching.

Described throughout, videos associated with video streams can be viewed by a user who is interested in the contents of the stream, curious about the stream, an avid follower of an individual associated with the stream, and so on. The stream associated with the video stream can be obtained from a server, a social media site, provided by an individual, provided by a brand, provided by a retailer, etc. An individual viewing the video associated with the video stream can make a selection of a product within the video stream content that can be of interest to the individual. The selection of the content such as a product can be indicated by clicking on an object presented along with the video stream, a link to an item shared by another viewer in a chat stream, a link embedded in the video stream, and the like. The content can be associated with a webpage, a product displayed on the website, a PDF, audio or image information scrubbed from the website, etc. A webpage by a third party can include one of a plurality of webpages that can be viewed by the individual. Webpage content can be rendered along with a reduced version of a video. The individual can interact with the webpage while the video stream continues to play. The rendering of webpage content and the reduced video can be viewed on an electronic device 1210. The electronic device can include a desktop or laptop computer, a tablet or smartphone, a personal digital assistant (PDA), and so on. The electronic device is coupled to a display 1212 on which a video such as a reduced video associated with a video stream 1214 can be rendered. The video stream can be rendered within a frame 1216. The frame can be used to display content such as the video stream, independent of the app, browser window, etc. that can contain the frame.

The video stream can be received from a video stream server 1218. The video stream server can include a web-based or cloud-based server, a local server, an electronic device associated with the provider of the video stream, etc. The video stream server can provide the video stream using a communication channel 1220. The communication channel can include a wired channel, a wireless channel, and the like. Described below, an individual can click on a product associated with the video stream. Website content 1222, which can include product information, additional information, etc., can be rendered within a frame 1224, where the frame 1224 can include a child frame. Embodiments include launching a child frame into which a webpage or other content is displayed. Note that in the system block diagram 1200, the frame within which the website content can be rendered surrounds the reduced video that is being rendered. The rendering the reduced video can accomplish a picture-within-picture function. The website content, rendered within the child frame 1224, can include a video, audio, text, etc. The rendering can be accomplished using an inline frame function within an Internet browser (web browser) application. The individual can view the video while she or he interacts with the content within the child frame. The interacting can include swiping, scrolling, or clicking links, radio buttons, menu selections, etc.

The system block diagram 1200 can include a product selection detector 1230. The product selection detector can detect that an individual has selected a product, where the product can include a product available on the third-party website, a product described by the provider or originator of the video stream, a product referenced in a chat associated with the video stream, a link embedded within the video stream etc. The product can be selected by clicking on a displayed product, swiping, selecting a link from a menu, mousing over a product, etc. The product selection can be received by the product selection detector using a communication channel such as a wireless communication channel 1232. The product selection detector can provide the product selection information to a native webpage 1240. The native webpage can include the webpage provided by the third party. The product selection detector server can provide access to product information by accessing a server 1242 that hosts the webpage. The providing can be accomplished by passing a callback function to the third party. The callback function can enable access to one or more functions associated with the webpage such as access to a shopping cart associated with the webpage. Access to the shopping cart can enable a user to collect objects of interest, such as products, services, and the like. The access to the third-party website shopping cart can enable the user to purchase products, services, etc., without having to exit from the rendering in order to navigate to the webpage. The third-party website server can provide the website content 1222 to the child frame using a communication channel. The communication channel can include a wireless 1244 communication channel.

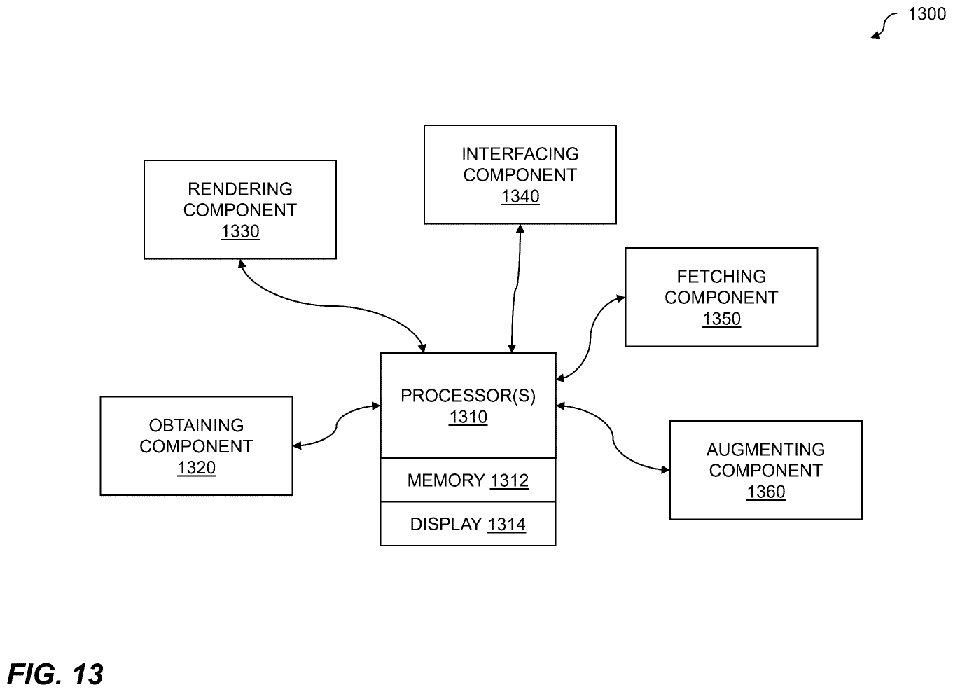

FIG. 13 is a system diagram for display. Video display is enabled by a video stream interface based on third-party webpage information. The system 1300 can include one or more processors 1310 coupled to a memory 1312 which stores instructions. The system 1300 can include a display 1314 coupled to the one or more processors 1310 for displaying data, video streams, videos, webpages, intermediate steps, instructions, and so on. In embodiments, one or more processors 1310 are coupled to the memory 1312 where the one or more processors, when executing the instructions which are stored, are configured to: obtain information on one or more products from a third-party information source; render, by a video user interface, to a user, a video about the one or more products; interface between the video user interface and the third-party information source, wherein interfacing is based on a user interaction with the video user interface; fetch product information associated with a product within the one or more products, wherein fetching is based on the interfacing between the video user interface and the third-party information source; and augment the video with further information based on the fetching of the product information associated with the product within the one or more products.

The system 1300 can include an obtaining component 1320. The obtaining component 1320 can include functions and instructions for obtaining information on one or more products from a third-party information source. The information can include a variety of data types including text, video, audio, and the like. The information can include promotional information such as coupons, promotions, “buy within 5 minutes and save” offers, etc. The information can include a description of a product; available options for the product such as size, color, and fit; availability of the product; shipping and handling charges associated with the product; promotions associated with the product; and so on. The products can include products listed in a database, presented on a website by a third-party (such as a brand, retailer, influencer, etc.), offered for sale, promoted, and the like. The one or more products can include a range of goods and/or services. The one or more products can include a product, a service, a coupon, a membership, a promotion, and so on.

The third party can comprise an individual, a company, a manufacturer, and so on. The third-party information source, from which the information can be obtained, can be varied. In some embodiments, the third-party information source comprises an online retailer. In some embodiments, the obtaining information is based on a website by a third party. The website can include a manufacturer site, an e-commerce site, a local reseller site, etc. The further information (e.g., the product information) can include information about similar products, a comparison of the product to similar products, a reaction, a chat, a transaction, an interaction, reviews, and so on, in addition to the examples listed above. The information can be obtained using a variety of techniques. In some embodiments, the obtaining information is accomplished by scrubbing text from the website by the third party. The “scrubbing” can be accomplished by obtaining information provided by the website owner or administrator, obtaining a snapshot of the website, or another method. The scrubbing can include obtaining links embedded in the text, determining links to other information, following the links to scrub additional information, and the like. The third-party information source can refer to a database locally owned but loaded with information from one or more third parties.

The system 1300 can include a rendering component 1330. The rendering component 1330 can include functions and instructions for rendering, by a video user interface, to a user, a video about the one or more products. The user interface can include a web browser, a video player app, a specialty app provided by a vendor or service, etc. The video that is rendered by the user interface can include a variety of video types such as a livestream, a livestream replay, a short-form video, or another video form. The video stream can include content such as news, sports, advertisements, political events, culture, popular news such as celebrity updates, real-time cute puppy and kitten videos, nature news, and so on. The rendering can be accomplished without a popup window. By forgoing use of one or more popup windows, video and webpage content can be rendered without a user having to change popup window blocking settings. Embodiments further include launching a child frame into which the webpage is displayed. The child frame can be associated with browser tab or window. In embodiments, the rendering can be accomplished using an inline frame function within an Internet browser application.

The system 1300 can include an interfacing component 1340. The interfacing component 1340 can include functions and instructions for interfacing between the video user interface and the third-party information source, wherein the interfacing is based on a user interaction with the video user interface. The user interaction can be determined based on a range of interaction detection techniques. In embodiments, the user interaction can be accomplished by mousing over an object in the video. The mousing can include moving a cursor using a mouse, a trackpad, a touchscreen, and the like. In other embodiments, the user interaction can be accomplished by clicking on an object in the video. The clicking can include clicking a mouse button, tapping a trackpad, touching a touchscreen, etc. The interfacing can include using techniques for harvesting information presented on a third-party website, accessing services on the third-party website, accessing a local or remote database, and so on.

In other embodiments, the interfacing can include passing a callback function from the video user interface to the third-party information source. A callback function, such as a callback junction in JavaScript™, can be passed as an argument to another function. The callback function can be used to accomplish a variety of operations. The callback function can include a list of objects being rendered in the video. The objects rendered in the video can include items for purchase, services offered, etc. The callback function can be updated when an object disappears from view on the video, appears in view, and the like. Thus, product information can be dynamically updated as the video plays, objects appear or disappear from view, the user interacts with the video, and so on. For example, product information can be highlighted for a frying pan while the video shows a chef using the pan. Later, the video may jump to a scene where the chef uses a pressure cooker. Accordingly, the product information can be updated to represent the pressure cooker. At any time, the user may mouse over, click on, or otherwise show interest in some object in the video and the information can switch to the object indicated. In some embodiments, the callback function is based on the user interaction. The interfacing can include a purchase selection for an object. The interfacing can enable a user to purchase an object through the video stream rather than having to switch applications from a video display app to a web browser or specialty app.

The system 1300 can include a fetching component 1350. The fetching component 1350 can include functions and instructions for fetching product information associated with a product within the one or more products, wherein the fetching is based on the interfacing between the video user interface and the third-party information source. Discussed above, the information that is fetched can include product information, product availability, product inventory levels, etc. In some embodiments, the interfacing can include a request for the further information on an object based on the user interaction. The further information can include information associated with new product releases, backorder status, repair service status, and the like. The further information associated with the one or more products can include a reaction, a chat, a transaction, a promotion, an interaction, etc. The further information can be obtained from the third-party website, from social media websites, from product review websites, from one or more databases, and the like. In embodiments, the obtaining information can be accomplished by scrubbing text from the third-party website. Other methods can be used to obtain information and further information.

The system 1300 can include an augmenting component 1360. The augmenting component 1360 can include functions and instructions for augmenting the video with further information based on the fetching of the product information associated with the product within the one or more products. The augmenting can include displaying the further information, featuring the further information, and so on. The augmenting can include updating the callback function discussed above when an object appears in or disappears from view on the video. The augmenting based on the further information can be accomplished using various techniques including video rendering techniques for display.

The system can include a computer program product embodied in a non-transitory computer readable medium for display, the computer program product comprising code which causes one or more processors to perform operations of: obtaining information on one or more products from a third-party information source; rendering, by a video user interface, to a user, a video about the one or more products; interfacing between the video user interface and the third-party information source, wherein the interfacing is based on a user interaction with the video user interface; fetching product information associated with a product within the one or more products, wherein the fetching is based on the interfacing between the video user interface and the third-party information source; and augmenting the video with further information based on the fetching of the product information associated with the product within the one or more products.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions-generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for display comprising:
obtaining information on one or more products from a third-party information source;
rendering, by a video user interface, to a user, a video about the one or more products;
interfacing between the video user interface and the third-party information source, wherein the interfacing is based on a user interaction with the video user interface;
fetching product information associated with a product within the one or more products, wherein the fetching is based on the interfacing between the video user interface and the third-party information source; and
augmenting the video with further information based on the fetching of the product information associated with the product within the one or more products.

2. The method of claim 1 wherein the obtaining information is based on a website by a third party.

3. The method of claim 2 wherein the obtaining information is accomplished by scrubbing text from the website by the third party.

4. The method of claim 1 wherein the fetching is based on a user selection of the product within the one or more products.

5. The method of claim 1 wherein the rendering comprises a first video segment, wherein the first video segment includes a synthetic human.

6. The method of claim 1 wherein the third-party information source comprises an online retailer.

7. The method of claim 1 wherein the user interaction is accomplished by mousing over an object in the video.

8. The method of claim 1 wherein the user interaction comprises showing interest in the product.

9. The method of claim 1 wherein the interfacing comprises a request for the further information on an object based on the user interaction.

10. The method of claim 1 wherein the interfacing comprises a purchase selection for an object.

11. The method of claim 1 wherein the interfacing comprises passing a callback function from the video user interface to the third-party information source.

12. The method of claim 11 wherein the interfacing is based on the user interaction.

13. The method of claim 11 further comprising updating the callback function when an object disappears from view on the video and the augmenting updates to remove information on the object that disappears.

14. The method of claim 11 further comprising updating the callback function when an object appears in view on the video and the augmenting includes information on the object that appears in view.

15. The method of claim 1 further comprising rendering a webpage based on the user interaction.

16. The method of claim 15 further comprising synchronizing information on the webpage with additional information shown on the video.

17. The method of claim 16 wherein the synchronizing includes displaying e-commerce shopping cart information on the webpage and video shopping cart information shown on the video.

18. The method of claim 16 wherein the synchronizing includes removing information on an object when the object disappears from view on the video.

19. The method of claim 16 wherein the synchronizing includes adding information on a new object in an associated webpage when the new object appears on the video.

20. The method of claim 16 further comprising performing cart synchronization between an e-commerce shopping cart on the webpage and a cart representation displayed over a portion of the video.

21. The method of claim 1 further comprising determining a plurality of objects within the video.

22. The method of claim 21 further comprising displaying information on each of the plurality of objects within the video.

23. The method of claim 22 wherein the displaying includes highlighting information on a webpage for an object, based on the user interaction.

24. The method of claim 22 wherein the displaying includes displaying information as an overlay on the video.

25. The method of claim 1 wherein the rendering and the fetching are accomplished on a same webpage.

26. The method of claim 1 wherein the interfacing comprises passing a callback function, as an argument to a second function, from the video user interface to the third-party information source based on the user interaction, and wherein the callback function is updated to augment information based on changes in product visibility as a result of the product from the one or more products disappearing from view on the video.

27. The method of claim 26 wherein the augmenting is based on the product visibility as a result of the product from the one or more products disappearing from view.

28. A computer program product embodied in a non-transitory computer readable medium for display, the computer program product comprising code which causes one or more processors to perform operations of:
obtaining information on one or more products from a third-party information source;
rendering, by a video user interface, to a user, a video about the one or more products;
interfacing between the video user interface and the third-party information source, wherein the interfacing is based on a user interaction with the video user interface;
fetching product information associated with a product within the one or more products, wherein the fetching is based on the interfacing between the video user interface and the third-party information source; and
augmenting the video with further information based on the fetching of the product information associated with the product within the one or more products.

29. A computer system for display comprising:
a memory which stores instructions;
one or more processors coupled to the memory wherein the one or more processors, when executing the instructions which are stored, are configured to:
obtain information on one or more products from a third-party information source;
render, by a video user interface, to a user, a video about the one or more products;
interface between the video user interface and the third-party information source, wherein interfacing is based on a user interaction with the video user interface;
fetch product information associated with a product within the one or more products, wherein fetching is based on the interfacing between the video user interface and the third-party information source; and
augment the video with further information based on the fetching of the product information associated with the product within the one or more products.
